(19) United States
(12) Patent Application Publication
(10) Pub. No.: US 2010/0028655 A1
(43) Pub. Date: Feb. 4, 2010

(54) WASHOFF-RESISTANT HYDRO- AND OLEOPHOBIC MELAMINE RESIN FOAM

(75) Inventors: Werner Lenz, Ludwigshafen (DE); Horst Baumgartl, Mainz (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/442,555

(22) PCT Filed: Sep. 13, 2007
(86) PCT No.: PCT/EP2007/059655

§ 371 Date: Mar. 24, 2009

(30) Foreign Application Priority Data
Sep. 25, 2006 (EP) 06121192.6

(51) Int. Cl. B32B 3/26; B05D 3/02

(52) U.S. Cl. 428/320.2; 427/393.5

(57) ABSTRACT

The surface of the cell scaffold of an open-cell melamine resin foam is wholly or partly coated with a mixture of fluorocarbon resin and modified polyisocyanate. The invention further relates to a process for producing this foam and to its use.

The present invention relates to an open-cell melamine-formaldehyde resin foam (or melamine resin foam for short) whose cell scaffold is coated with a mixture of fluorocarbon resin and modified polyisocyanate as hydrophobicizing and oleophobicizing agent.

Open-cell foams formed from melamine-formaldehyde polycondensation plastics possess excellent acoustical absorption and thermal insulation properties. These foamed plastics or plastic foams are also notable for fire safety and high resistance to heat. Their low density rounds out this attractive assortment of properties.

Accordingly, such open-cell foams formed from melamine-formaldehyde polycondensation plastics, or melamine resin foam for short, are used in building and transportation for the purpose of noise reduction and/or energy saving.

Particularly the use in transportation, for example in automotive construction, rail vehicles and ship building entails that the melamine resin foam will come into contact with liquid media, for example in the form of lubricating oil, rainwater or condensation. Similarly, contamination with liquid media is possible in engine test stands and machine enclosures in which melamine resin foam is used to reduce noise.

Owing to its open-cell constitution and the absorption characteristics of its base material, melamine resin, melamine resin foam is able to take up large amounts of liquid. In direct contact with water, a melamine resin foam will become saturated in the same way as a cleaning sponge for example. The water take-up amounts to above 90 volume percent (% by volume). The same holds for contact with engine oil, although here the take-up is somewhat less owing to the higher viscosity. For example, an oil take-up of about 80% by volume was found in direct contact with engine oil of SAE viscosity class 10 W.

The take-up of liquid changes the acoustical and thermal insulating properties, i.e., the sound absorption ability reduces, in particular at high frequencies above 1000 Hz and the thermal insulating properties come to be dominated by the thermal conductivity values of the liquid media absorbed, and they are generally less favorable than those of the uncontaminated melamine resin foam.

To reduce the take-up of liquid, foamed plastics or plastic foams can be impregnated with suitable chemicals to render them water or oil repellent.

For instance, the oleophobicization of an open-cell melamine resin foam is described in U.S. Pat. No. 6,607,817 B1 and DE 100 11 388 A1. The oleophobicizing agent specified is fluorocarbon resin, which has hydrophobic properties as well as an oil-repellent effect.

DE 100 11 388 A1 utilized Dipolit® 480 fluorocarbon resin from Rotta to render open-cell melamine resin foams water and oil repellent. Dipolit 480 was diluted in water and applied by wet impregnation. The solids content of this emulsion can be 0.1 to 20% and preferably 0.2 to 2% to achieve an excellent water- and oil-repellent effect.

Thus, the water take-up of Basotect® having a density of 9 g/l decreases from about 99% by volume to about 0.07% by volume in a floating test over 150 min after impregnation in a Dipolit® 480 emulsion having a solids content of 0.2% by weight and subsequent drying at temperatures >20° C., preferably 120-160° C. These tests were carried out using Basotect samples measuring 100×100×20 mm. The samples were completely drenched in the Dipolit 480 emulsion and excess liquid was subsequently squeezed off in a two-roll stand. Oil take-up decreases from about 80% by volume to about 0.1 % by volume by virtue of the impregnation described above.

A significant disadvantage of coating with fluorocarbon resin alone is that the coating can be easily washed off by liquid media such as water. This problem arises in particular in vehicle or aircraft construction when the surface of the hydro- and oleophobicized melamine resin foam comes into contact with splashed water or water of condensation. For example, Basotect® melamine resin foam is used for noise insulation in the engine compartment of motor vehicles and is exposed there to splashed water in certain circumstances. The same holds for aircraft construction, where melamine resin foam is used for thermal-acoustical insulation of the cabins. Similarly, when used as a sound absorber in indoor pools or in ship building, exposure to splashed water is likely.

Exposure of the foam to water generally leads to the protective, hydro- and oleophobicizing layer becoming washed off. Consequently, there is nothing to stop water entering on renewed exposure. Water with which the foam comes into contact can disrupt the desired acoustical absorption and thermal insulation.

A 5 minute flushing test with pressurized water shows that there is significant deterioration in or loss of hydrophobic properties. The 9 to 10 g/l density melamine resin samples impregnated with fluorocarbon resin resin dispersion in the process described above—where the solids content was 0.2% by weight—were no longer hydrophobic where they had come into contact with water. Water droplet tests carried out after back-drying show that the droplets are able to freely penetrate into the foam just like untreated melamine resin foam.

It is an object of the present invention to provide melamine resin foam with a hydro- and oleophobic coating that provides prolonged washoff resistance to contact with liquid media.

We have found that this object is achieved by utilizing a hydro- and oleophobicizing mixture consisting of a) fluorocarbon resin and b) a modified polyisocyanate.

Modified polyisocyanates useful as component b include for example b1 hydrophilicized polyisocyanates and b2 nonionogenic polyurethanes such as, in particular, Evo® Gard XL (from DyStar, corresponds to Rotal® 444 from Rotta).

Useful polyisocyanates include in particular tolylene 2,4-diisocyanate, tolylene 2,6-diisocyanate, naphthylene 1,5-diisocyanate, 4,4′-diphenylmethane diisocyanate, isophorone diisocyanate and hexamethylene diisocyanate, but also other aromatic or aliphatic polyisocyanates.

Modification is to be understood as meaning in particular a hydrophilicization of the isocyanate as obtainable by reaction of the polyisocyanate with polyethers, fatty acids, silanes, aminoethanesulfonic acids, urethanes (allophanate modification) or polyols (nonionogenic polyurethanes). The modified polyisocyanates are typically prepared using a molar excess of diisocyanate to thereby obtain modified polyisocyanates having free isocyanate groups. These free isocyanate groups are preferably at least partly blocked. The isocyanate groups can be blocked using compounds having acidic hydrogen atoms. Useful blocking agents include for example dimethylpyrazole, diacetyl, caprolactam or substituted or unsubstituted phenols. Particularly preferred blocking agents include ketone oximes, in particular butanone oxime, acetone oxime or methyl isobutyl ketone oxime. The preparation of modified polyisocyanates is described in the literature.

Examples are Evo® Gard XL (from DyStar, corresponds to Rotal® 444 from Rotta). These can be homogeneously mixed with fluorocarbon resin and applied in a conventional manner, i.e., wet impregnation by spraying or dipping, or foam application.

Fluorocarbon resins useful as component a include partially or fully fluorinated C₁-C₁₀ esters of methacrylic acid, of poly(meth)acrylic acid, of phosphoric acid or of C₁-C₆ fatty acids or else of C₃-C₆-alkanedicarboxylic acids. Preferably, the alkyl groups of the esters and/or of the alcohol component are perfluorinated. Examples are Evo®Gard FCS (from DyStar, corresponds to Dipolit® CS 97382 from Rotta) or Evo®Gard FSU (from DyStar, corresponds to Dipolit® 480 from Rotta).

The present invention's hydro- and oleophobicization of melamine resin foam is preferably realized by impregnating the foam with an aqueous impregnating solution comprising 0.1 to 10% by weight and preferably 0.2% to 2% by weight of component a and 0.1% to 10% by weight and preferably 0.2% to 2% by weight of component b. Particular preference is given to an impregnating solution of the following composition I (solids fraction in % by weight):

| | |
|---|---|
| a) Fluorocarbon resin (Evo ® Gard FCS) | 0.5% by weight |
| b) Modified polyisocyanate (Evo ® Gard XL) | 0.5% by weight |
| Water | 99.0% by weight |

Also efficient are of course similar impregnating solutions, the same or other solids being used in the same or if appropriate other mixing ratios. Preference is given to using waterborne impregnating solutions, although other solvents such as ketones, alcohols or esters are suitable as well. Solvents can also be used in the form of mixtures with water. Water can also be used in the form of distilled water. It has been determined that particularly homogeneous impregnating solutions are obtainable with distilled water.

The foams in the coated state comprise 0.01% to 10% by weight and preferably 0.1% to 5% by weight each of coating components a and b. In general, the two components a and b are used in approximately equimolar amounts. Good washoff resistance is also obtained with samples coated with 4 to 10 times the weight-based excess of component a.

Use example

### EXAMPLE 1

Foams impregnated with impregnating solution I

| | |
|---|---|
| a) Fluorocarbon resin (Evo ® Gard FCS) | 0.5% by weight |
| b) Modified polyisocyanate (Evo ® Gard XL) | 0.5% by weight |
| Water | 99.0% by weight |

proved to be particularly washoff resistant.

The thus dip-impregnated ultralight Basotect samples having an envelope density of 6 g/l and measuring 200×150×20 mm were pressed in a two-roll stand to <5% of their initial height of 20 mm and subsequently dried in a circulating air oven at 160° C. to constant weight.

Thereafter, a brief washoff test was carried out and the samples dried. For this purpose, the impregnated samples were placed in a waterbath. The water was 10 cm deep. The hydro- and oleophobic samples were pushed to the bottom of the waterbath and compressed to such an extent that all the air enclosed in the samples was able to escape. After removal from the waterbath, the samples were again subjected to mechanical compression until water ceased to drip out of them. This washing operation was carried out ten times in succession. The subsequent back-drying took place at 160° C. to constant weight of the samples. The conclusive short-time dip test gave a water take-up of 0.9% by volume and hence corresponded to the level of the reference sample which had not been washed off. In the short-time dip test, the samples were pushed below the water surface by means of a metal grid. The depth of immersion was 13 cm, the immersion time was 15 min. A balance is used to record the change in mass of the samples due to water take-up and the associated change in buoyancy.

### COMPARATIVE EXAMPLE 2

In a comparative test, the foam was impregnated with an impregnating solution consisting of 99% by weight of water and 1% by weight of Evo® Gard FCS (but without Evo® Gard XL) in the same way as in example 1. Washoff test and short-time dip test were carried out as in example 1. The foam of comparative example 2 gave a water take-up of 1.2% by volume. This corresponded to a 33% higher value.

As the abovementioned examples illustrate, the washoff behavior of coated melamine resin foams can be decisively improved by the present invention's coating. This increases safety, consistency and reliability when using hydro- and oleophobic melamine resin in relevant applications under similar stress situations.

1. A melamine resin foam wherein the surface of its cell scaffold is wholly or partly coated with a mixture consisting of
a) fluorocarbon resin and
b) modified polyisocyanate.

2. The melamine resin foam according to claim 1 wherein the coated foam comprises 0.01% to 10% by weight of fluorocarbon resin and 0.01% to 10% by weight of modified polyisocyanate.

3. The melamine resin foam according to claim 1 wherein modified polyisocyanate is nonionogenic polyurethane.

4. A process for producing a foam according to claim 1, which comprises spraying or drenching the foam with an aqueous dispersion of a fluorocarbon resin and of a modified polyisocyanate, squeezing off excess liquid and drying the foam at 120 to 200° C.

5. The process according to claim 4 wherein the dispersion has a 0.1% to 10% by weight solids content each of a fluorocarbon and of a modified polyisocyanate.

6. (canceled)

7. A process for producing a foam according to claim 2, which comprises spraying or drenching the foam with an aqueous dispersion of a fluorocarbon resin and of a modified polyisocyanate, squeezing off excess liquid and drying the foam at 120 to 200° C.

8. A process for producing a foam according to claim 3, which comprises spraying or drenching the foam with an aqueous dispersion of a fluorocarbon resin and of a modified polyisocyanate, squeezing off excess liquid and drying the foam at 120 to 200° C.
